(19) United States
(12) Patent Application Publication
(10) Pub. No.: US 2009/0276088 A1
(43) Pub. Date: Nov. 5, 2009

(54) Vending System and Method

(76) Inventor: John Ruddy, Newport, RI (US)

Correspondence Address: Sunstein Kann Murphy & Timbers LLP, 125 SUMMER STREET, BOSTON, MA, 02110-1618, US

(21) Appl. No.: 12/434,332

(22) Filed: May 1, 2009

Related U.S. Application Data
(60) Provisional application No. 61/050,061, filed on May 2, 2008.

(51) Int. Cl. G06F 17/00; B65G 59/00

(52) U.S. Cl. 700/232; 221/199

(57) ABSTRACT

A method of dispensing an age-restricted item from a vending machine at a first location is presented. The method includes receiving age documentation from a purchaser at a second location remote from the first location. The age of the purchaser is verified at the second location based on the received age documentation and direct visual inspection of the purchaser. Upon verification, a signal is sent from the second location to the vending machine that allows dispensing of the item. From the second location, it is visually verified that the purchaser receives the item from the vending machine at the first location.

### CROSS-REFERENCE TO RELATED APPLICATIONS

This application claims priority from U.S. Provisional Application No. 61/050,061 filed on May 2, 2008, entitled “Vending System and Method,” which is incorporated herein by reference in its entirety.

### TECHNICAL FIELD

The present invention relates to a vending system and method, and more particularly, to a vending system and method for controlling the dispensing of beer or other restricted items.

### BACKGROUND ART

Purchasing items, such as beer or cigarettes, often require age verification of the buyer. The typical vending machine is inadequate in this regard, having a simple interface in which a beverage or other item is provided based on depositing a certain amount of money. More advanced machines include a video capture device that captures video of the buyer, which is then communicated to a remote terminal for approval prior to dispensing the item, as disclosed in U.S. Patent Application 2002/0087413, which is hereby incorporated by reference in its entirety. However, such machines are relatively complex and expensive. and open up potential for fraud by the purchaser.

Additionally, legal hours of operation are often an issue with conventional vending machines, particularly if the vending machine is located in a non-restricted public area. For example, the selling of liquor is typically prohibited after a certain hour of night or on certain days of the week, such as on Sunday. Individuals in charge of granting permission/control to purchase the beer may themselves be prone to illegal operation of the vending machine after permitted hours.

### SUMMARY OF THE INVENTION

In accordance with a first embodiment of the invention, a method of dispensing an age-restricted item from a vending machine at a first location is presented. The method includes receiving age documentation from a purchaser at a second location remote from the first location. The age of the purchaser is verified at the second location based on the received age documentation and direct visual inspection of the purchaser. Upon verification, a signal is sent from the second location to the vending machine that allows dispensing of the item. From the second location, it is visually verified that that the purchaser receives the item from the vending at the first location.

In accordance with related embodiments of the invention, the method may further include, prior to sending of the signal, purchasing of the item by the purchaser at the second location. Sending the signal may include sending the signal via at least one of a wireless and a wired interface. The item may be, for example, alcohol, beer, and/or cigarettes. Verifying may further include determination that the purchaser is not intoxicated.

In accordance with further embodiments of the invention, a first controller may be provided at the second location, wherein the method includes controlling the first controller to send the signal to the vending machine. The first controller may include: an operator interface for sending the signal to the vending machine; and/or a locking mechanism to prevent unauthorized use of the controller. The method may further include unlocking the locking mechanism prior to sending the signal.

In accordance with still further embodiments of the invention, the method may further include restricting dispensing of said item to a predetermined time of operation. Restricting dispensing of said item to the predetermined time of operation may include using a timing device. Restricting dispensing of said item to the predetermined time of operation may include restricting the sending of the signal from the second location to the vending machine to a predetermined time of operation. A second controller may control the first controller so as to restrict sending of the signal. The method may include setting the predetermined time at the second controller. In various embodiments, only an authorized operator may set the predetermined time at the second controller.

In accordance with another embodiment of the invention, a system for dispensing an item includes a vending machine. The vending machine includes a dispenser for dispensing said item. A first controller restricts dispensing of said item to a predetermined time of operation.

In accordance with related embodiments of the invention, the item is an age-restricted item, such as alcohol, beer, and/or cigarettes. The first controller may include an operator interface for adjusting the predetermined time of operation. A locking mechanism may prevent unauthorized adjustment of the predetermined time of operation. The locking mechanism may include password verification. The first controller may be located within the vending machine.

In accordance with further related embodiments of the invention, the system may include a second controller for positioning at a location remote from the vending machine, the second controller including an operator interface for sending a signal to the vending machine that controls, at least in part, dispensing of the item. The second controller may be operatively coupled to the vending machine via a wireless and/or wired interface. The second controller may include a locking mechanism to prevent unauthorized use. The first controller may prevent the second controller from sending a signal that allows dispensing of the item. The first controller may be located at the location remote from the vending machine.

In accordance with another embodiment of the invention, a system for dispensing an item includes a vending machine having a dispenser for dispensing said item. A control means restricts dispensing of said item to a predetermined time of operation.

In accordance with related embodiments of the invention, the item is an age-restricted item, such as alcohol, beer, and/or cigarettes. The control means may include an operator interface for adjusting the predetermined time of operation. A locking mechanism may preventing unauthorized adjustment of the predetermined time of operation. The locking mechanism may include password verification.

In accordance with further related embodiments of the invention, the system may further include a second control means for positioning at a location remote from the vending machine. The second control means including an operator interface for sending a signal to the vending machine that controls, at least in part, dispensing of the item. The second control means may be operatively coupled to the vending machine via a wireless and/or wired interface. The second control means may include a locking mechanism to prevent unauthorized use. The first control means may prevent the second control means from sending a signal that allows dispensing of the item. The first control means may be located at the location remote from the vending machine.

### BRIEF DESCRIPTION OF THE DRAWINGS

The foregoing features of the invention will be more readily understood by reference to the following detailed description, taken with reference to the accompanying drawings, in which:

FIG. 1 shows a method of dispensing a restricted item from a vending machine located at a first location, in accordance with one embodiment of the invention; and

FIG. 2 is a simplified block diagram illustrating a vending machine at a first location, and a controller at a second location, in accordance with an embodiment of the invention.

### DETAILED DESCRIPTION OF SPECIFIC EMBODIMENTS

In illustrative embodiments of the invention, a system and method for dispensing restricted items, such as beer, is presented. The control of “off hour” sales that are illegal, and/or the restriction of sales to under-aged individuals is addressed. Various embodiments, for example, allow a hotel employee working at a front desk in a lobby to visually verify an age of a purchaser, and upon verification, to control from the front desk a beer vending machine located elsewhere in the lobby. Embodiments of the invention also include restricting a vending machine in dispensing of items to a predetermined time of operation. For example, a timing device may restrict dispending of the item to the predetermined time of operation. Details are discussed below.

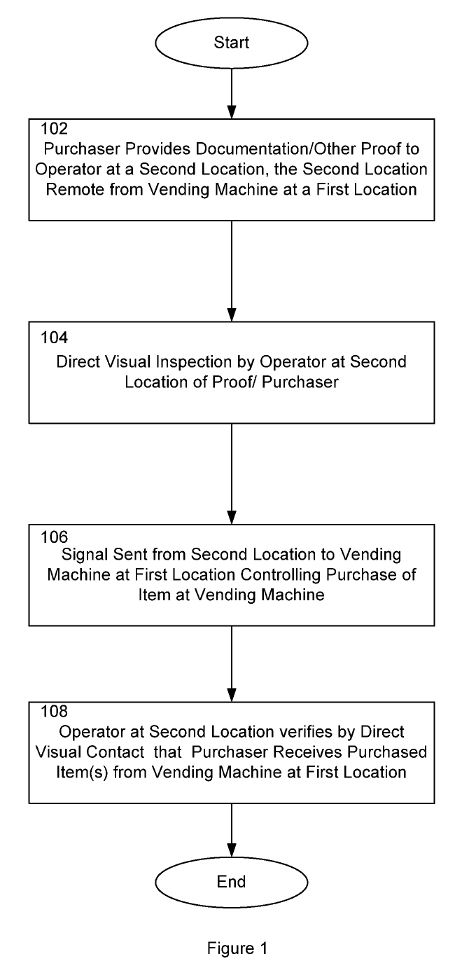

FIG. 1 shows a method of dispensing a restricted item from a vending machine located at a first location. The restricted item may include, without limitation, alcoholic products (such as beer or wine), cigarettes, ammunition, and/or medication. The item may be restricted based on a wide variety of conditions, such as age, mental ability, training, and/or ownership of a license.

The method begins at step 102, in which a purchaser at a second location remote from the first location provides documentation or other proof necessary to purchase the restricted item. For example, in connection with the purchase of alcohol, a purchaser may need to provide age documentation and/or picture identification, such as a license.

The method continues to step 104, wherein the proof necessary to purchase the restricted item is verified at the second location. In various embodiments, this step may include not only verification of various documentation, but also direct visual inspection of the purchaser by an operator at the second location. For example, when a license is provided by a purchaser of alcohol, it is often required to verify that the picture on the license matches the purchaser. Furthermore, it is often necessary to visually inspect the purchaser of alcohol for intoxication. This verification and/or visual inspection may be performed by a human operator authorized to control the vending machine, such as a hotel employee operating a front desk.

In addition to verification, the purchaser may also be required to provide payment for the restricted item at the second location. In other embodiments, payment may occur at the vending machine by, without limitation, inserting money into the vending machine, or use of a credit card.

Upon verification and/or payment, a signal(s) is sent from the second location to the vending machine at the first location, step 106, allowing for the dispensing of the restricted item. The signal(s) may be sent, for example, by manipulating a controller at the second location to provide the signal(s) to the vending machine. The signal(s) may include, without limitation, the quantity and/or type of items that are permitted to be dispensed from the vending machine.

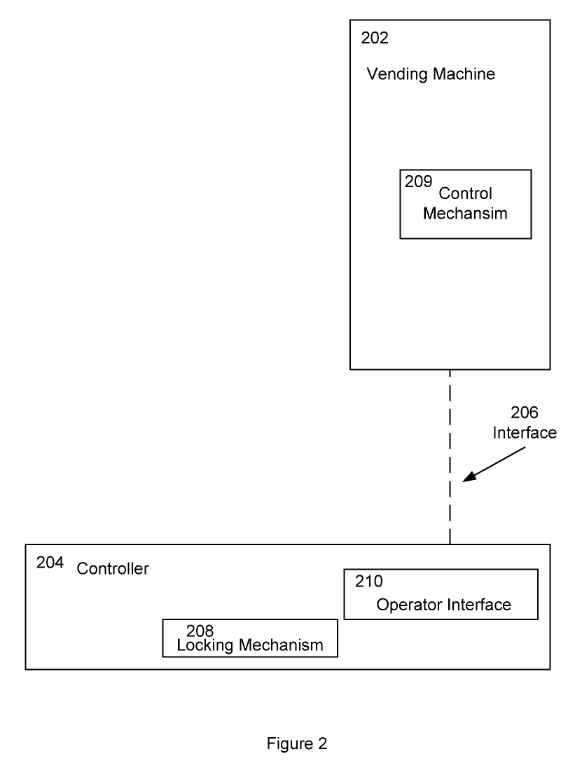

FIG. 2 is a simplified block diagram illustrating a vending machine 202 at a first location, and a controller 204 at a second location, in accordance with an embodiment of the invention. The controller 204 may be operatively coupled to the vending machine 202 via a wireless or wired interface 206, as know by one of skill in the art. The interface 206 may be analog or digital. Interface 206 may be part of a network, such as the Internet or a private network, and utilize, for example Internet Protocol (IP). The controller may interface with a plurality of vending machines via the interface 206. Communication from the controller 204 to the vending machine 202 may be unidirectional or bidirectional. Signals provided between the controller 204 and the vending machine may pertain to, without limitation, identification, control, status, inventory, and/or diagnostics.

In various embodiments, the controller 204 may be non-sophisticated, and include, for example, analog switching logic to control signals sent to and/or from the vending machine. In other embodiments, the controller 204 may be, at least in part, implemented but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof as a computer program product for use with, for example, a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques ( e.g., microwave, infrared or other transmission techniques). The series of computer instructions embodies all or part of the functionality described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

The controller 204 may include an operator interface 210 for controlling the sending and/or receiving of the signal(s) to and from the vending machine 202, respectively. The operator interface 210 may include, without limitation, one or more switches, displays, a touchpad, and/or a keypad. Illustratively, the operator may enter a number on a keypad that is communicated via the signal(s) to the vending machine 202, and which indicates the number of items that are to be dispensed. The controller 204 and/or the vending machine 202 may further include diagnostics/indicators/alerts that confirm proper operation of the interface 206, vending machine 202, and/or controller 204.

In various embodiments, the controller 204 may further include a locking mechanism 208 to prevent unauthorized use of the controller 204. Locking mechanism may be, without limitation, mechanical and/or electrical. For example, the controller 204 may have a lockable, hinged door that provides access to control of the venting machine 202. Unlocking the locking mechanism 206 by an authorized operator may include, without limitation, using a key, a bar code reader and/or entering a password/access code at a keypad. Alternatively, or in combination with a door, the locking mechanism 208 may include entry of a password or other identification via an operator interface such as, without limitation, a keypad, barcode reader, touch panel. In various embodiments, the controller may include two or more locking mechanisms.

Furthermore, the controller 204 may include memory and control logic for storing a record of the transaction. The record may include, without limitation, the time of the transaction, the vending machine number associated with the transaction, the type of item dispensed from the vending machine, and/or the quantity of item(s) dispensed from the vending machine. The record may be used, for example, in keeping a running inventory of the items in the vending machine. An alert and/or indicator may be provided that notifies the operator that a certain item in the vending machine needs to be refilled. The record may also indicate who the operator of the controller 204 was for a given transaction. Such a record may be based, in part, on the password provided by the operator in allowing operation of the controller 204. Such a record may be used, for example, to monitor fraudulent transactions. In various embodiments, a record of the purchaser may be stored. For example, the controller 204 may include a scanner, and a scan of a purchaser's license or other photoidentification may be stored.

The vending machine 202 is capable of storing and vending restricted item(s). Items(s) dispensed by the vending machine may also include non-restricted items. The vending machine 202 may include, without limitation, a dispenser for dispensing of said item(s), and one or more push buttons that allow the purchaser to select and/or purchase one or more of the item(s). In embodiments in which payment for the item(s) occurs at the second location remote from the vending machine 202, the controller 204 may communicate via the interface 206 the quantity of items that may be selected and provided. Alternatively, the vending machine 202 may include a currency acceptance mechanism for receiving money from the purchaser, who can then select one or more of the items, up to the number of items that may be purchased, as communicated by controller 204. In various embodiments, the vending machine may include, for example, a card reader, for reading a credit card of a purchaser.

Referring back to FIG. 1, the method optionally continues to step 108, in which the operator at the second location visually verifies that the purchaser receives the purchased item(s) from the vending machine 202 at the first location. In preferred embodiments, the vending machine 202 is in the line of sight of the operator at the controller 204, allowing for direct visual contact. This allows the operator at the second location to visually observe that the verified purchaser, and not a different purchaser, receives the item from the vending machine 202.

In illustrative embodiments of the invention, the vending machine 202 or controller 204 may include a control mechanism 209 that restricts dispensing of the item(s) to a predetermined time of operation. For example, the control mechanism may restrict operation to legal hours of operation. More particularly, the control mechanism 209 may prevent, without limitation, dispensing of the restricted item to on Sundays, and/or after closing hours of an establishment. Control mechanism 209 may be implemented alone, or in conjunction with controller 204. Control mechanism 209 may be located within the vending machine 202 or controller 204. Alternatively, the control mechanism 209 may be a stand-alone unit that is separate from, and which interfaces with, the vending machine 202 and controller 203.

In various embodiments, the control mechanism 209 may be, without limitation, a timing device that is programmed or otherwise directed to allow dispensing of the item at the predetermined time of the operation, and restrict the dispensing of the item at times other than the predetermined time of operation. In various embodiments, the control mechanism 209 may deactivate, or otherwise prevent, the controller 204 from sending a signal that allows dispensing of the restricted item. Thus, even if an operator attempts to send the signal from controller 204, the control mechanism 209 will prevent dispensing of the restricted item if not within the predetermined time of operation.

Control mechanism 209 may include various circuitry and/or be, at least in part, implemented but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof as a computer program product for use with, for example, a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

The control mechanism 209 may include an operator interface for adjustment of the predetermined time of operation. For example, the operator interface 209 may include, without limitation, a display and/or touchpanel, a keypad or various pushbuttons (similar, for example, to those used on watches) to adjust the predetermined time of operation.

The operator interface associated with control mechanism 209 may include a locking mechanism for preventing unauthorized adjustment of the predetermined time of operation. Locking mechanism may be mechanical and/or electrical. For example, a password or a key may be required prior to changing the predetermined time of operation.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A method of dispensing an age-restricted item from a vending machine at a first location, the method comprising:
at a second location remote from the first location, receiving age documentation from a purchaser;
verifying, at the second location, an age of the purchaser based on the received age documentation and direct visual inspection of the purchaser;
upon verification, sending a signal from the second location to the vending machine that allows dispensing of the item; and
verifying, by direct visual contact from the second location, that the purchaser receives the item from the vending machine at the first location.

2. The method according to claim 1, further comprising, prior to sending of the signal, purchasing of the item by the purchaser at the second location.

3. The method according to claim 1, wherein sending the signal includes sending the signal via a wireless interface.

4. The method according to claim 1, wherein there is a first controller at the second location, wherein the method includes controlling the first controller to send the signal to the vending machine.

5. The method according to claim 4, wherein the first controller further includes a locking mechanism to prevent unauthorized use of the first controller, wherein the method further includes unlocking the locking mechanism prior to sending the signal.

6. The method according to claim 4, further comprising restricting sending the signal from the second location to the vending machine to a predetermined time of operation.

7. The method according to claim 6, wherein a second controller controls the first controller so as to restrict sending of the signal to a predetermined time of operation.

8. The method according to claim 6, further comprising setting the predetermined time at the second controller.

9. The method according to claim 8, wherein only an authorized operator can set the predetermined time at the second controller.

10. The method according to claim 1, wherein the item is at least one of alcohol, beer, medication and cigarettes.

11. The method according to claim 1, wherein verifying further includes determination that the purchaser is not intoxicated.

12. The method according to claim 1, further comprising restricting dispensing of said item to a predetermined time of operation.

13. The method according to claim 12, wherein restricting dispensing of said item to the predetermined time of operation includes using a timing device.

14. A system for dispensing an item, the system comprising:
a vending machine including a dispenser for dispensing said item; and
a first controller for restricting dispensing of said item to a predetermined time of operation.

15. The system according to claim 14, wherein the item is at least one of an age-restricted item, alcohol, beer, medication and cigarettes.

16. The system according to claim 14, wherein the first controller includes an operator interface for adjusting the predetermined time of operation.

17. The system according to claim 16, further comprising a locking mechanism for preventing unauthorized adjustment of the predetermined time of operation.

18. The system according to claim 17, wherein the locking mechanism includes password verification.

19. The system according to claim 14, wherein the first controller is located within the vending machine.

20. The system according to claim 14, further comprising:
a second controller for positioning at a location remote from the vending machine, the second controller including an operator interface for sending a signal to the vending machine that controls, at least in part, dispensing of the item.

21. The system according to claim 20, wherein the second controller is operatively coupled to the vending machine via at least one of a wireless and wired interface.

22. The system according to claim 20, wherein the second controller includes a locking mechanism to prevent unauthorized use.

23. The system according to claim 20, wherein the first controller prevents the second controller from sending a signal that allows dispensing of the item.

24. The system according to claim 23, wherein the first controller is located at the location remote from the vending machine.
